(19) United States
(12) Patent Application Publication
(10) Pub. No.: US 2020/0400297 A1
(43) Pub. Date: Dec. 24, 2020

(54) LIGHTING APPARTUS IN CLOSET

(71) Applicant: XIAMEN ECO LIGHTING CO. LTD., Xiamen (CN)

(72) Inventors: Shouqiang HOU, Xiamen (CN); Xiaoliang WEN, Xiamen (CN)

(21) Appl. No.: 16/859,980

(22) Filed: Apr. 27, 2020

(30) Foreign Application Priority Data
Jun. 20, 2019 (CN) CN201920932857.5
Jun. 20, 2019 (CN) CN201920936316.X
Jun. 20, 2019 (CN) CN201920937794.2

(51) Int. Cl. F21V 23/00; F21V 23/04; F21S 8/00; H05B 45/20

(52) U.S. Cl. CPC F21V 23/007; F21V 23/0471; F21Y 2115/10; H05B 45/20; F21S 8/035

(57) ABSTRACT

A lighting apparatus includes a light source module, a light passing cover, a base plate, a first end module and a second end module. The light source module includes a plurality of LED modules. These LED modules may have different types. Each type has a different optical parameter, like color temperature, color, light intensity, color rendering index. The light passing cover allows a light of the light source module to pass through. The base plate is connected to the light passing cover forming a container space. The base plate has an elongated shape. The first end module and the second end module are attached at two opposite ends of the base pate for sealing the container space. The first end module is selectively connected to another second end module of another lighting apparatus for routing electricity and a control signal.

### FIELD

The present application is related to a lighting apparatus and more particularly related to a lighting apparatus used in a closet.

### BACKGROUND

Electroluminescence, an optical and electrical phenomenon, was discovered in 1907. Electroluminescence refers the process when a material emits light when a passage of an electric field or current occurs. LED stands for light-emitting diode. The very first LED was reported being created in 1927 by a Russian inventor. During decades' development, the first practical LED was found in 1961, and was issued patent by the U.S. patent office in 1962. In the second half of 1962, the first commercial LED product emitting low-intensity infrared light was introduced. The first visible-spectrum LED, which limited to red, was then developed in 1962.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

With high light output, LEDs are available across the visible, infrared wavelengths, and ultraviolet lighting fixtures. Recently, there is a high-output white light LED. And this kind of high-output white light LEDs are suitable for room and outdoor area lighting. Having led to new displays and sensors, LEDs are now be used in advertising, traffic signals, medical devices, camera flashes, lighted wallpaper, aviation lighting, horticultural grow lights, and automotive headlamps. Also, they are used in cellphones to show messages.

A Fluorescent lamp refers to a gas-discharge lamps. The invention of fluorescent lamps, which are also called fluorescent tubes, can be traced back to hundreds of years ago. Being invented by Thomas Edison in 1896, fluorescent lamps used calcium tungstate as the substance to fluoresce then. In 1939, they were firstly introduced to the market as commercial products with variety of types.

In a fluorescent lamp tube, there is a mix of mercury vapor, xenon, argon, and neon, or krypton. A fluorescent coating coats on the inner wall of the lamp. The fluorescent coating is made of blends of rare-earth phosphor and metallic salts. Normally, the electrodes of the lamp comprise coiled tungsten. The electrodes are also coated with strontium, calcium oxides and barium. An internal opaque reflector can be found in some fluorescent lamps. Normally, the shape of the light tubes is straight. Sometimes, the light tubes are made circle for special usages. Also, u-shaped tubes are seen to provide light for more compact areas.

Because there is mercury in fluorescent lamps, it is likely that the mercury contaminates the environment after the lamps are broken. Electromagnetic ballasts in fluorescent lamps are capable of producing buzzing mouse. Radio frequency interference is likely to be made by old fluorescent lamps. The operation of fluorescent lamps requires specific temperature, which is best around room temperature. If the lamps are placed in places with too low or high temperature, the efficacy of the lamps decreases.

In real lighting device design, details are critical no matter how small they appear. For example, to fix two components together conveniently usually brings large technical effect in the field of light device particularly when any such design involves a very large number of products to be sold around the world.

In some specific use, lighting devices may have different design concerns. For example, some lighting apparatuses are designed to be placed in a closet. When users open the closet, they do not need to rely only external light to illuminate the inner space of the closet. It is beneficial and challenging to design such lighting apparatuses to be more convenient and easier to be used while providing more flexible functions.

### SUMMARY

In some embodiments, a lighting apparatus includes a light source module, a light passing cover, a base plate, a first end module and a second end module.

The light source module includes a plurality of LED modules. These LED modules may have different types. Each type has a different optical parameter, like color temperature, color, light intensity, color rendering index.

The light passing cover allows a light of the light source module to pass through.

The base plate is connected to the light passing cover forming a container space. The base plate has an elongated shape.

The first end module and the second end module are attached at two opposite ends of the base pate for sealing the container space. The first end module is selectively connected to another second end module of another lighting apparatus for routing electricity and a control signal. Specifically, such lighting apparatus has great scalability. More than one same type of different types of such lighting apparatuses may be connected in series once they have the same first end mode and the second end module.

For example, the first end module of a first lighting apparatus is connected to the second end module of a second lighting apparatus. The first end of the second lighting apparatus is connected to the second end module of a third lighting apparatus. The first end module may be connected to a power source, e.g. a battery pack, a power adaptor converting 110V/220V alternating current source to a DC power source, or an indoor power socket when the first end box has a driver for converting the indoor power to a DC power source.

Other lighting apparatus, like the second lighting apparatus and the third lighting apparatus may receive power from the first lighting apparatus. In this example, the third lighting apparatus receives power from the second lighting apparatus.

In addition to route electricity from one lighting apparatus to another lighting apparatus, control signals and other parameter settings may be transmitted among the lighting apparatuses.

For example, a turn-on command, a color temperature adjustment command, a adding-intensity (adding luminance level), audio data, synchronous signals for multiple lighting apparatuses to work together in time, may be routed to the connected lighting apparatuses.

In some embodiments, the first end module and the second end module may have cover housings for concealing the container space together with the light passing cover and the base plate. Specifically, the first end module may include plastic or other material housing component to be attached to the base plate. In addition, the first end module may have electricity components to convert power, rectify power, filter power, parse control command, route messages to a next lighting apparatus.

In some embodiments, the first end module may be detached from the lighting apparatus and be replaced with another end module with the same housing so as to connect to a second end module of another lighting apparatus, but include different circuits within the first end module. For example, some first end module may have the same appearance as other first end modules, but have wireless circuit for receiving wireless data from an external device. For a series of connected lighting apparatuses, not necessary every lighting apparatus has the capability of wireless transmission, which may cause higher cost. Instead, if one lighting apparatus has the wireless transmission function, other lighting apparatuses may receive an external command via the lighting apparatus.

It is even better that people may choose the first end modules with different functions and integrate the first end module to the lighting apparatus to satisfy their needs.

All function mentioned above may be implemented at the second end module at the same time. In some other embodiments, some circuits may be placed in the first end module and some other circuits may be placed in the second end module. The first end module and the second end module may co-work together for provide desired function together.

When the first end module is detachable, there is an inner connector for connecting to the first end module. The inner connector may have the same connecting structures as the first end module while the first end module has an additional connector structure as the second end module.

Specifically, the first end module is connected to the inner connector with its connector like the second end module. In such design, the first end module is just like another lighting apparatus, just without a light source module.

More than one first end modules may be connected in series and then connected to one lighting apparatus for providing necessary functions. These first end modules may have different functions, and their connection provides combined functions.

In some embodiments, the light source module is disposed on the base plate.

In some embodiments, the light source module is located at the first end module for emitting light to a light guide disposed on the base plate.

In some embodiments, the light guide is integrated with the light passing cover.

In some embodiments, the light guide is detachable to be removed from the base plate and replaced with another light guide.

For example, different colors or light guides may be replaced for providing a different light effect.

In some embodiments, the first end module and the second end module have different structures. The first end module has a pluggable structure corresponding to the second end module.

For example, the first end module may have a male connector structure while the second end module have female connector structure. With such structures, multiple lighting apparatuses may be connected in series. The head lighting apparatus may receive electricity and control signals and routes the electricity and the control signals to other connected lighting apparatuses.

In some embodiments, the lighting apparatus is installed in a closet for connecting a socket getting an electricity supply.

In some embodiments, a door sensor of the closet triggers a driver circuit in the first end module to turn on the light source module when an associated door is open.

In some embodiments, the first end module is removable to be replaced with another first end module with different parameters.

In some embodiments, the first end module has at least one slot for plugging in at least one function module.

In some embodiments, multiple function modules are plugged and interact together with a driver in the first end module.

In some embodiments, a first end of a forking connector is connected to the first end module and multiple second ends are connected to another second end modules of another multiple lighting apparatuses.

In some embodiments, the first end module has a manual switch for selecting a parameter set optimized for an object category, multiple object categories are selectable on the manual switch.

For example, a first parameter set is optimized for projecting light on clothing. A second parameter set is optimized for projecting light on jewelry. A third parameter set is optimized for projecting light on cups and dishes.

This is different from manual switches only provided for selecting a desired color temperature or a color rendering index.

Most people do not have knowledge and sensitivity to adjust the light to optimize the visual effect when the light is projected to different objects.

But, such function is critical for projecting lights on objects when they are installed in closet or a gallery box.

Common used parameter sets may be optimized and stored for users to select one object category.

It is possible for providing an advanced setting on such manual switch.

For example, the same parameter set may correspond to different control signals when the light source module is used in day time or night time.

In some other embodiments, the parameter set may be downloaded from Internet and transmitted to the lighting apparatus by an external device like a mobile phone.

In some embodiments, the lighting apparatus may also include a function module with a third end module and a fourth end module, the third end module having the same structure as the first end module, the fourth end module having the same structure as the second end module, the fourth end module is connected to the first end module.

The function module is made as the lighting apparatus mentioned above, just such function module does not encompass a light source module but a function circuit, e.g. a wireless module, a sensor, a processor.

Such function module is connected to the first end module to extend the lighting apparatus. The extended lighting apparatus still has a first end module using the third end module to connect to another second box of another lighting apparatus.

In some embodiments, the first end module has a battery module for supplying power to the light source module.

In some embodiments, multiple lighting apparatuses are connected in series forming a frame.

In some embodiments, a length of the base plate is adjustable.

In some embodiments, the lighting apparatus may also include a pose sensor for detecting a pose to place the lighting apparatus and a driver of the lighting apparatus controls the light source module to emit different lights when the lighting apparatus is placed horizontally and when the lighting apparatus is placed vertically.

In some embodiments, the lighting apparatus may also include a rotation structure attached to the base plate for adjusting an output light direction of the light source module.

In some embodiments, a control message of the lighting apparatus is transmitted to another lighting apparatus.

In some embodiments, multiple lighting apparatuses connected in series are synchronized to work together to emit a collaborative light effect.

In some embodiments, the first end module has a manual switch for setting a parameter of the light source module.

In some embodiments, the first end module has a slot for inserting a memory card, the memory card stores parameters for controlling the light source module.

The memory card may be inserted to an external computer for downloading or editing. The parameters and settings are then put back to the lighting apparatus when the memory card is inserted to the lighting apparatus.

### BRIEF DESCRIPTION OF DRAWINGS

FIG. 1 illustrates a connection of multiple lighting apparatuses.

FIG. 2 illustrates an exploded view of a lighting apparatus example.

FIG. 3 illustrates an exploded view of a smart device.

FIG. 4 illustrates an embodiment used in a closet.

FIG. 5 illustrates a fork component.

FIG. 6 illustrates another component example.

FIG. 7A and FIG. 7B illustrate a lighting apparatus with adjustable length.

FIG. 8 illustrates a frame structure made by multiple lighting apparatuses.

### DETAILED DESCRIPTION

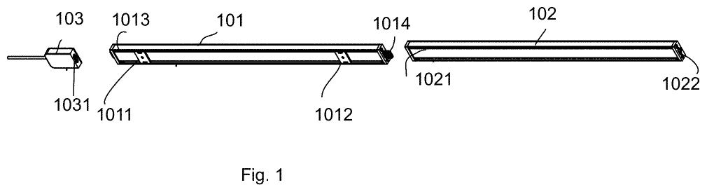

In FIG. 1, a first lighting apparatus 101 has a first end module 1013 and a second end module 1014. A second lighting apparatus 102 has a first end module 1021 and a second end module 1022. The first lighting apparatus 101 and the second lighting apparatus 102 are placed in a closet. There are fixing connectors 1011, 1012 for fixing to the closet. The first lighting apparatus 101 is then placed to the fixing connectors 1011, 1012 to fix to the closet.

The first end module 1013, 1021 have associated connecting structures for connecting to the second end modules 1014, 1022. Specifically, the second end module 104 is connected to the first end module 1021 of the second lighting apparatus. If there is a third lighting apparatus, the first end of the third lighting apparatus is connected to the second end module 1022 of the second lighting apparatus. With such logic, more lighting apparatuses may be connected in series.

In addition, there is a smart device 103. The smart device 103 has a connector structure 1031 similar to the second end modules 1014, 1022. The first end module 1013 is connected to the connector structure 1031 of the smart device 103.

The smart device 103 may be connected to an indoor power socket installed in a closet. The smart device 103 has a driver for converting the indoor power 110V or 220V to DC current supplied to the first lighting apparatus 101 and the second lighting apparatus 102. In such example, the smart device 103 supplies necessary direct current directly to the first lighting apparatus 101 and the second lighting apparatus 102. In other words, the first lighting apparatus 101 may not need to have conversion circuit for converting indoor power to direct current. In addition, the first lighting apparatus 101 and the second lighting apparatus 102 share the same power circuit of the smart device 103 and such design lowers overall cost of the lighting apparatuses.

In some embodiments, the first end modules 1013, 1021 may include driver circuits. In such design, the first lighting apparatus 101 and the second lighting apparatus 102 may be connected directly to an indoor power source and convert the 110V/220V power to driving current with integrated drivers in the first lighting apparatus 101 and the second lighting apparatus 102.

In some embodiments, even each lighting apparatus includes a driver circuit, the driver circuit may be disabled when a direct current is detected supplied from a smart device 103 or another lighting apparatus.

In such design, the driver circuit does not operate and thus does not generate heat. In closet application, it is important to prevent unnecessary heat to keep safety particularly when there are many stuffs easily to get fired. In the same time, the lighting apparatus is still convenient to function even users do not buy a smart device 103 or another lighting apparatus.

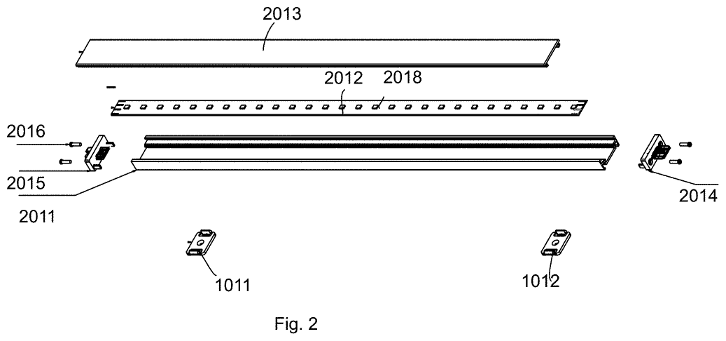

In FIG. 2, a lighting apparatus has a light passing cover 2013, a light source module 2012, a base plate 2011. The light source module 2012 includes multiple LED modules 2018.

The light source module 2012 is placed on the base plate 2011. The base plate 2011 is made of metal material for efficient heat dissipation. The base plate 211 and the light passing cover 2013 form a container space. The light source module 2012 is placed in the container space. In some embodiments, the light source module 2012 has an elongated substrate that is inserted into a track of the base plate 2011 to fix the light source module 2012 to the base plate 2011.

A first end module 2015 and a second end module 2014 are attached on two opposite sides of the base plate 2011. Screws 2016 may be used for fixing the first end module 2015 to the base plate 2011. The fixing connectors 1011, 1012 are used for fixing the lighting apparatus to a surface when the fixing connectors 1011, 1012 are firstly fixed to the surface.

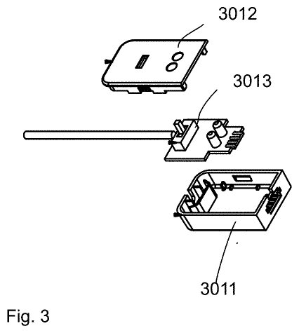

FIG. 3 illustrates a smart device. The smart device has a top cover 3012 and a bottom cover 3011. The top cover 3012 and the bottom cover 3011 form a similar connector structure as the second end module of the lighting apparatus mentioned above and thus is connectable to a first end module of a lighting apparatus. A circuit board 3013 includes an electrical connector for connecting to a first end module of a lighting apparatus for transmitting power and/or control signals.

The smart device may receive a wireless command to turn on or to turn off one or more connected lighting apparatuses. Other operation like color temperature adjustment may also be made by the smart device from receiving command of an external device like a mobile phone or a remote control.

In some embodiments, the light source module is disposed on the base plate.

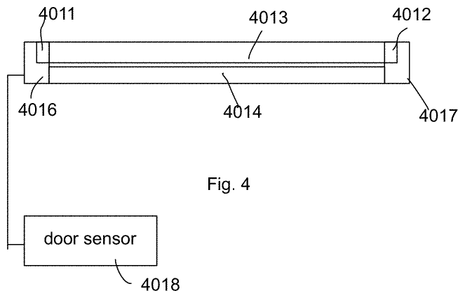

In FIG. 4, the lighting apparatus has a first end module 4016 and a second end module 4017. There are light source modules 4011, 4012 disposed in the first end module 4016 and the second end module 4017. The light of the light source modules 4011, 4012 are emitted to the light guide 4013, which also serves the light passing cover and is placed on the base plate 4014.

In some embodiments, the light guide may be replaced with another light guide with different parameters.

In some embodiments, the light guide is integrated with the light passing cover.

In some embodiments, the light guide is detachable to be removed from the base plate and replaced with another light guide.

For example, different colors or light guides may be replaced for providing a different light effect.

In some embodiments, a lighting apparatus includes a light source module, a light passing cover, a base plate, a first end module and a second end module.

The light source module includes a plurality of LED modules. These LED modules may have different types. Each type has a different optical parameter, like color temperature, color, light intensity, color rendering index.

The light passing cover allows a light of the light source module to pass through.

The base plate is connected to the light passing cover forming a container space. The base plate has an elongated shape.

The first end module and the second end module are attached at two opposite ends of the base pate for sealing the container space. The first end module is selectively connected to another second end module of another lighting apparatus for routing electricity and a control signal. Specifically, such lighting apparatus has great scalability. More than one same type of different types of such lighting apparatuses may be connected in series once they have the same first end mode and the second end module.

For example, the first end module of a first lighting apparatus is connected to the second end module of a second lighting apparatus. The first end of the second lighting apparatus is connected to the second end module of a third lighting apparatus. The first end module may be connected to a power source, e.g. a battery pack, a power adaptor converting 110V/220V alternating current source to a DC power source, or an indoor power socket when the first end box has a driver for converting the indoor power to a DC power source.

Other lighting apparatus, like the second lighting apparatus and the third lighting apparatus may receive power from the first lighting apparatus. In this example, the third lighting apparatus receives power from the second lighting apparatus.

In addition to route electricity from one lighting apparatus to another lighting apparatus, control signals and other parameter settings may be transmitted among the lighting apparatuses.

For example, a turn-on command, a color temperature adjustment command, a adding-intensity (adding luminance level), audio data, synchronous signals for multiple lighting apparatuses to work together in time, may be routed to the connected lighting apparatuses.

In some embodiments, the first end module and the second end module may have cover housings for concealing the container space together with the light passing cover and the base plate. Specifically, the first end module may include plastic or other material housing component to be attached to the base plate. In addition, the first end module may have electricity components to convert power, rectify power, filter power, parse control command, route messages to a next lighting apparatus.

In some embodiments, the first end module may be detached from the lighting apparatus and be replaced with another end module with the same housing so as to connect to a second end module of another lighting apparatus, but include different circuits within the first end module. For example, some first end module may have the same appearance as other first end modules, but have wireless circuit for receiving wireless data from an external device. For a series of connected lighting apparatuses, not necessary every lighting apparatus has the capability of wireless transmission, which may cause higher cost. Instead, if one lighting apparatus has the wireless transmission function, other lighting apparatuses may receive an external command via the lighting apparatus.

It is even better that people may choose the first end modules with different functions and integrate the first end module to the lighting apparatus to satisfy their needs.

All function mentioned above may be implemented at the second end module at the same time. In some other embodiments, some circuits may be placed in the first end module and some other circuits may be placed in the second end module. The first end module and the second end module may co-work together for provide desired function together.

When the first end module is detachable, there is an inner connector for connecting to the first end module. The inner connector may have the same connecting structures as the first end module while the first end module has an additional connector structure as the second end module.

Specifically, the first end module is connected to the inner connector with its connector like the second end module. In such design, the first end module is just like another lighting apparatus, just without a light source module.

More than one first end modules may be connected in series and then connected to one lighting apparatus for providing necessary functions. These first end modules may have different functions, and their connection provides combined functions.

In some embodiments, the light source module is disposed on the base plate.

In some embodiments, the light source module is located at the first end module for emitting light to a light guide disposed on the base plate.

In some embodiments, the light guide is integrated with the light passing cover.

In some embodiments, the light guide is detachable to be removed from the base plate and replaced with another light guide.

For example, different colors or light guides may be replaced for providing a different light effect.

In some embodiments, the first end module and the second end module have different structures. The first end module has a pluggable structure corresponding to the second end module.

For example, the first end module may have a male connector structure while the second end module have female connector structure. With such structures, multiple lighting apparatuses may be connected in series. The head lighting apparatus may receive electricity and control signals and routes the electricity and the control signals to other connected lighting apparatuses.

In some embodiments, the lighting apparatus is installed in a closet for connecting a socket getting an electricity supply.

In FIG. 4, a door sensor of the closet triggers a driver circuit in the first end module to turn on the light source module when an associated door 4018 is open.

In some embodiments, the first end module is removable to be replaced with another first end module with different parameters.

In some embodiments, the first end module has at least one slot for plugging in at least one function module.

In some embodiments, multiple function modules are plugged and interact together with a driver in the first end module.

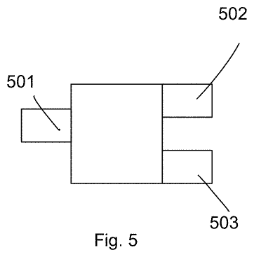

In FIG. 5, a first end of a forking connector 501 is connected to the first end module and multiple second ends 502, 503 are connected to another second end modules of another multiple lighting apparatuses.

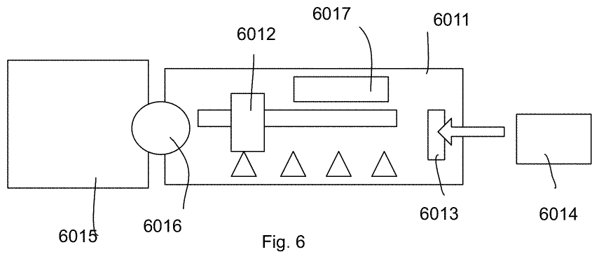

In FIG. 6, the first end module 6011 has a manual switch 6012 for selecting a parameter set optimized for an object category, multiple object categories are selectable on the manual switch.

For example, a first parameter set is optimized for projecting light on clothing. A second parameter set is optimized for projecting light on jewelry. A third parameter set is optimized for projecting light on cups and dishes.

This is different from manual switches only provided for selecting a desired color temperature or a color rendering index.

Most people do not have knowledge and sensitivity to adjust the light to optimize the visual effect when the light is projected to different objects.

But, such function is critical for projecting lights on objects when they are installed in closet or a gallery box.

Common used parameter sets may be optimized and stored for users to select one object category.

It is possible for providing an advanced setting on such manual switch.

For example, the same parameter set may correspond to different control signals when the light source module is used in day time or night time.

In some other embodiments, the parameter set may be downloaded from Internet and transmitted to the lighting apparatus by an external device like a mobile phone.

In some embodiments, the lighting apparatus may also include a function module with a third end module and a fourth end module, the third end module having the same structure as the first end module, the fourth end module having the same structure as the second end module, the fourth end module is connected to the first end module.

The function module is made as the lighting apparatus mentioned above, just such function module does not encompass a light source module but a function circuit, e.g. a wireless module, a sensor, a processor.

Such function module is connected to the first end module to extend the lighting apparatus. The extended lighting apparatus still has a first end module using the third end module to connect to another second box of another lighting apparatus.

In FIG. 6, the first end module has a battery module 6017 for supplying power to the light source module.

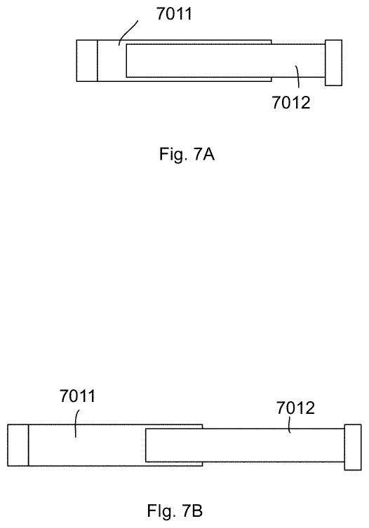

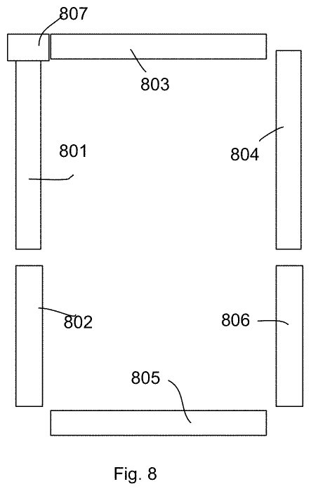

In FIG. 8, multiple lighting apparatuses 801, 802, 803, 804, 805, 806 are connected in series forming a frame. As explained in FIG. 7A and FIG. 7B, such lighting apparatus may be adjusted for their lengths to fit to a closet. For corner portion, a corner connector 807 may be used for rotatable first end module may be used for forming a frame shape structure.

In FIG. 7A and FIG. 7B, a length of the base plate is adjustable. Specifically, the base plate has a first portion 7011 and a second portion 7012. The first portion 7011 and the second portion 7012 are shifted to change a total length of the lighting apparatus, as illustrated in FIG. 7A and FIG. 7B.

In some embodiments, the lighting apparatus may also include a pose sensor for detecting a pose to place the lighting apparatus and a driver of the lighting apparatus controls the light source module to emit different lights when the lighting apparatus is placed horizontally and when the lighting apparatus is placed vertically.

In FIG. 6, the lighting apparatus may also include a rotation structure 6016 attached to the base plate 6015 for adjusting an output light direction of the light source module.

In some embodiments, a control message of the lighting apparatus is transmitted to another lighting apparatus. For example, a signal line or multiple signal lines may be used for routing information like control signals and disposed to the first end module and the second end module.

In some embodiments, multiple lighting apparatuses connected in series are synchronized to work together to emit a collaborative light effect.

In some embodiments, the first end module has a manual switch for setting a parameter of the light source module. For example, a series of electronic signals like 0100101, wherein 0 represents low voltage level and 1 represents high voltage level, is used as a sync signal. In addition to connect the lighting apparatuses in series for routing power electricity, control signals are routed too. Such sync signal is recognized by a processor in the first end module and translated to synchronize action with other lighting apparatuses for executing a predetermined program.

In previous embodiments, function modules or processing circuits are installed in the first end module. These functions and circuits may also be partially placed in the second end module or other places of the lighting apparatus, e.g. a driver circuit in the middle of the base plate mentioned above.

In FIG. 6, the first end module 6011 has a slot 6013 for inserting a memory card 6014, the memory card 6014 stores parameters for controlling the light source module.

The memory card may be inserted to an external computer for downloading or editing. The parameters and settings are then put back to the lighting apparatus when the memory card is inserted to the lighting apparatus.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a light source module comprising a plurality of LED modules;
a light passing cover, for allowing a light of the light source module to pass through;
a base plate connected to the light passing cover forming a container space, the base plate having an elongated shape;
a first end module; and
a second end module, wherein the first end module and the second end module are attached at two opposite ends of the base pate for sealing the container space, the first end module is selectively connected to another second end module of another lighting apparatus for routing electricity and a control signal.

2. The lighting apparatus of claim 1, wherein the light source are located at the first end module for emitting light to a light guide disposed on the base plate.

3. The lighting apparatus of claim 1, wherein the first end module and the second end module have different structures, the first end module has a pluggable structure corresponding to the second end module.

4. The lighting apparatus of claim 1, wherein the lighting apparatus is installed in a closet for connecting a socket getting an electricity supply.

5. The lighting apparatus of claim 4, wherein a door sensor of the closet triggers a driver circuit in the first end module to turn on the light source module when an associated door is open.

6. The lighting apparatus of claim 1, wherein the first end module is removable to be replaced with another first end module with different parameters.

7. The lighting apparatus of claim 1, wherein the first end module has at least one slot for plugging in at least one function module.

8. The lighting apparatus of claim 7, wherein multiple function modules are plugged and interact together with a driver in the first end module.

9. The lighting apparatus of claim 7, wherein a first end of a forking connector is connected to the first end module and multiple second ends are connected to another second end modules of another multiple lighting apparatuses.

10. The lighting apparatus of claim 7, wherein the first end module has a manual switch for selecting a parameter set optimized for an object category, multiple object categories are selectable on the manual switch.

11. The lighting apparatus of claim 1, further comprising a function module with a third end module and a fourth end module, the third end module having the same structure as the first end module, the fourth end module having the same structure as the second end module, the fourth end module is connected to the first end module.

12. The lighting apparatus of claim 1, wherein the first end module has a battery module for supplying power to the light source module.

13. The lighting apparatus of claim 1, wherein multiple lighting apparatuses are connected in series forming a frame.

14. The lighting apparatus of claim 13, wherein a length of the base plate is adjustable.

15. The lighting apparatus of claim 13, further comprising a pose sensor for detecting a pose to place the lighting apparatus and a driver of the lighting apparatus controls the light source module to emit different lights when the lighting apparatus is placed horizontally and when the lighting apparatus is placed vertically.

16. The lighting apparatus of claim 1, further comprising a rotation structure attached to the base plate for adjusting an output light direction of the light source module.

17. The lighting apparatus of claim 1, wherein a control message of the lighting apparatus is transmitted to another lighting apparatus.

18. The lighting apparatus of claim 17, wherein multiple lighting apparatuses connected in series are synchronized to work together to emit a collaborative light effect.

19. The lighting apparatus of claim 1, wherein the first end module has a manual switch for setting a parameter of the light source module.

20. The lighting apparatus of claim 1, wherein the first end module has a slot for inserting a memory card, the memory card stores parameters for controlling the light source module.
